(19) United States
(12) Patent Application Publication
(10) Pub. No.: US 2017/0129725 A1
(43) Pub. Date: May 11, 2017

(54) TRANSPORTING DEVICE, TRANSPORTING SYSTEM, AND IMAGE FORMING APPARATUS

(71) Applicant: FUJI XEROX CO., LTD., Tokyo (JP)

(72) Inventors: Toshinori SASAKI, Kanagawa (JP); Koichi KIMURA, Kanagawa (JP); Mizuki SUGINO, Kanagawa (JP); Mitsutoshi HONGO, Kanagawa (JP)

(73) Assignee: FUJI XEROX CO., LTD., Tokyo (JP)

(21) Appl. No.: 15/082,066

(22) Filed: Mar. 28, 2016

(30) Foreign Application Priority Data
Nov. 10, 2015 (JP) 2015-220471

(51) Int. Cl. B65H 5/02; B65H 5/06; G03G 15/00; B65H 29/12

(52) U.S. Cl. CPC B65H 5/023; B65H 29/12; B65H 5/026; B65H 5/068; G03G 15/6529

(57) ABSTRACT

A transporting device includes a first belt, a second belt that transports a medium in cooperation with the first belt, a first shifting member that shifts the first belt in a width direction of the first belt, a second shifting member that shifts the second belt in a width direction of the second belt, a rotatable member that is rotatable around its own axis, and a forming member provided across the first belt and the second belt from the rotatable member and that forms a nip between the first and second belts in cooperation with the rotatable member. The rotatable member and the forming member cooperate to form the nip at a pressure ratio lower than about 1. The pressure ratio is obtained by dividing a pressure applied to each of two axial ends of the rotatable member by a pressure applied to an axial center of the rotatable member.

### CROSS-REFERENCE TO RELATED APPLICATIONS

This application is based on and claims priority under 35 USC 119 from Japanese Patent Application No. 2015-220471 filed Nov. 10, 2015.

### BACKGROUND

### Technical Field

The present invention relates to a transporting device, a transporting system, and an image forming apparatus.

### SUMMARY

According to an aspect of the invention, there is provided a transporting device including a rotatable first belt, a rotatable second belt that transports a medium in cooperation with the first belt, a first shifting member around which the first belt is provided and that shifts the first belt in a width direction of the first belt, a second shifting member around which the second belt is provided and that shifts the second belt in a width direction of the second belt, a rotatable member around which the first belt is provided and that is rotatable around an axis of the rotatable member, and a forming member provided across the first belt and the second belt from the rotatable member and that forms a nip between the first belt and the second belt in cooperation with the rotatable member. The rotatable member and the forming member cooperate to form the nip at a pressure ratio lower than about 1. The pressure ratio is obtained by dividing a pressure applied to each of two axial ends of the rotatable member by a pressure applied to an axial center of the rotatable member.

### BRIEF DESCRIPTION OF THE DRAWINGS

Exemplary embodiments of the present invention will be described in detail based on the following figures, wherein:

FIG. 1 is a schematic front view of an image forming apparatus according to an exemplary embodiment;

FIG. 2 is a schematic front view of a cooling device included in the image forming apparatus according to the exemplary embodiment;

FIG. 3 is a schematic diagram of the cooling device according to the exemplary embodiment that is seen in the apparatus-width direction and illustrates a state where a driving roller and an elastic roller included in the cooling device cooperate to form a nip between a first belt and a second belt;

FIG. 4 is a graph illustrating a distribution, in the axial direction of the driving roller (in the width direction of the first belt), of pressure applied to the first belt and the second belt held between the driving roller and the elastic roller according to the exemplary embodiment;

FIG. 5 is a schematic diagram of a cooling device according to a first comparative embodiment that is seen in the apparatus-width direction and illustrates a state where a driving roller and an elastic roller included in the cooling device cooperate to form a nip between a first belt and a second belt;

FIG. 6 is a schematic diagram of a cooling device according to a second comparative embodiment that is seen in the apparatus-width direction and illustrates a state where a driving roller and an elastic roller included in the cooling device cooperate to form a nip between a first belt and a second belt;

FIG. 7 is a graph illustrating a distribution, in the axial direction of the driving roller (in the width direction of the first belt), of pressure applied to the first belt and the second belt held between the driving roller and the elastic roller according to each of the first and second comparative embodiments;

FIG. 8 is a graph illustrating a relationship between a ratio of a value of the pressure applied to the first and second belts, held between the driving roller and the elastic roller, at each axial end of the driving roller (the elastic roller) to a value of the pressure at the axial center and a rate at which the first or second belt is shifted in the width direction (in the axial direction of the driving roller (the elastic roller));

FIG. 9 is a graph illustrating a relationship between the ratio of the value of the pressure applied to the first and second belts, held between the driving roller and the elastic roller, at each axial end of the driving roller (the elastic roller) to the value of the pressure at the axial center and a rate at which a medium is transported;

FIG. 10 is a schematic diagram of a cooling device according to a first modification that is seen in the apparatus-width direction and illustrates a state where a driving roller and an elastic roller included in the cooling device cooperate to form a nip between a first belt and a second belt; and

FIG. 11 is a schematic diagram of a cooling device according to a second modification that is seen in the apparatus-width direction and illustrates a state where a driving roller and an elastic roller included in the cooling device cooperate to form a nip between a first belt and a second belt.

### DETAILED DESCRIPTION

### Outline

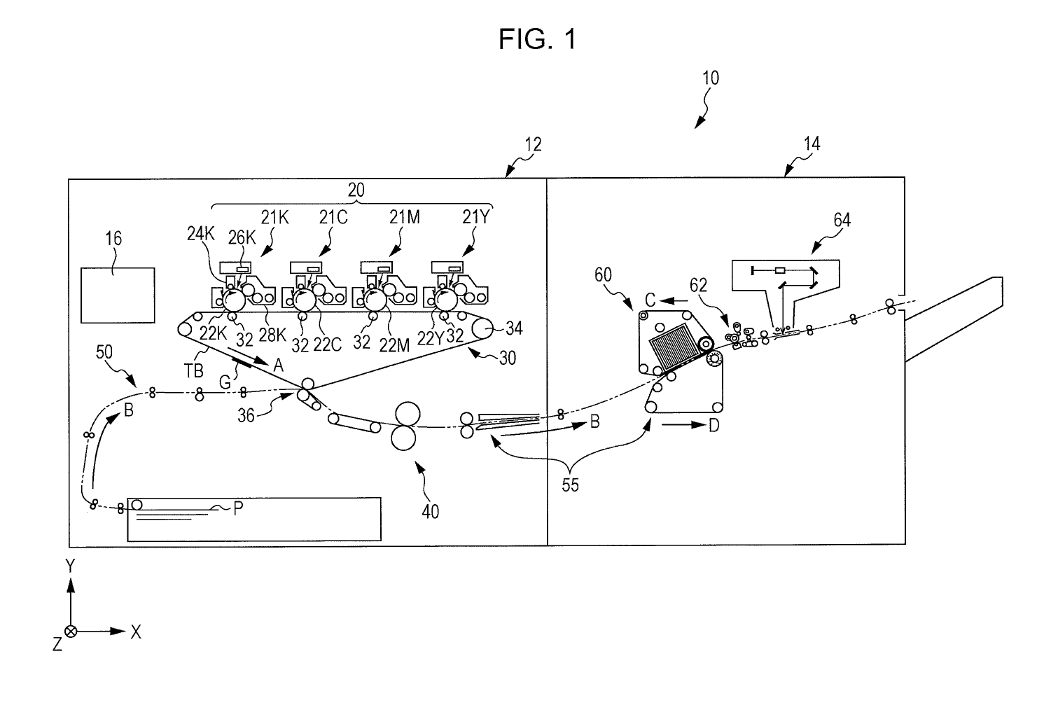

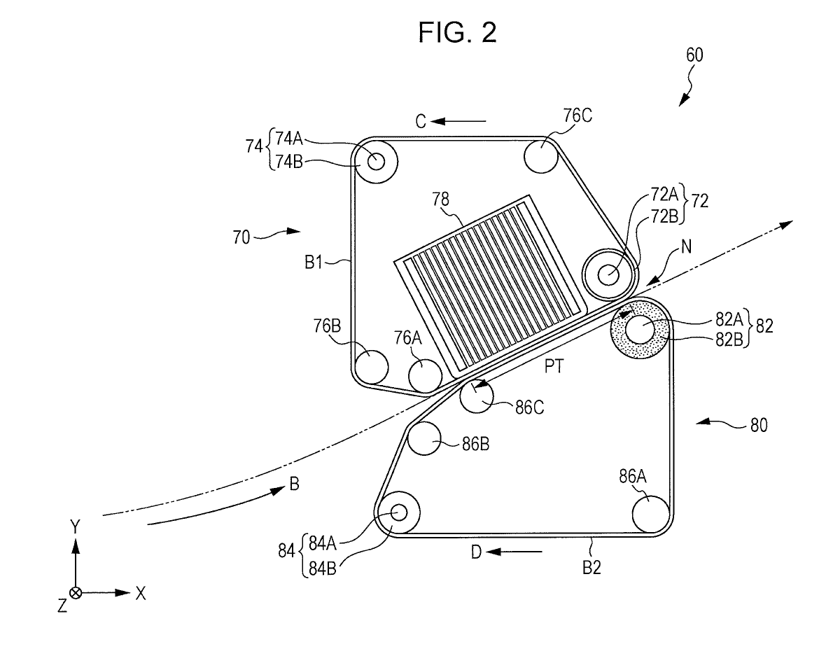

First, an outline of a configuration and an operation (including an image forming operation and a post-forming operation) of an image forming apparatus 10 (see FIG. 1) according to an exemplary embodiment of the present invention will be described. Then, a cooling device 60 (see FIGS. 1 and 2) featured in the exemplary embodiment will be described. Lastly, functions exerted by the exemplary embodiment will be described.

In the drawings to be referred to below, the direction indicated by an arrow Y is defined as “apparatus-height direction,” the direction indicated by an arrow X is defined as “apparatus-width direction,” and the direction indicated by an arrow Z and orthogonal to each of the apparatus-height direction and the apparatus-width direction is defined as “apparatus-depth direction.” Furthermore, in FIG. 1, the front side of the image forming apparatus 10 corresponds to the near side in the apparatus-depth direction.

### Configuration of Image Forming Apparatus

Referring to FIG. 1, the image forming apparatus 10 is an electrophotographic apparatus and includes an image forming section 12, a post-forming-operation section 14, and a controller 16.

### Image Forming Section

The image forming section 12 forms an image on a medium P that is transported by a transporting portion 50 (a transporting mechanism 55) to be described later. As illustrated in FIG. 1, the image forming section 12 includes a toner-image-forming portion 20, a transfer device 30, a fixing device 40, and the transporting portion 50.

### Toner-Image-Forming Portion

The toner-image-forming portion 20 forms a toner image G on an intermediate transfer belt TB (hereinafter referred to as “belt TB”) through steps of charging, exposure, and development. The belt TB, to be described later, is included in the transfer device 30.

The toner-image-forming portion 20 includes monochrome units 21Y, 21M, 21C, and 21K that form monochrome toner images in different colors of yellow (Y), magenta (M), cyan (C), and black (K) on photoconductors 22Y, 22M, 22C, and 22K, respectively. The toner-image-forming portion 20 is capable of forming a toner image G composed of such monochrome toner images in plural colors in accordance with image data. The monochrome units 21Y, 21M, 21C, and 21K all have the same configuration, except the colors of the monochrome toner images to be formed. Hereinafter, if there is no need to distinguish the monochrome units 21Y, 21M, 21C, and 21K and associated elements provided thereto from one another by the colors, the suffixes (Y, M, C, and K) given to respective reference numerals are omitted. The monochrome units 21 each include the photoconductor 22, a charging device 24, an exposure device 26, and a developing device 28. In FIG. 1, reference numerals of elements provided to the monochrome units 21 excluding the monochrome unit 21K are omitted.

### Transfer Device

The transfer device 30 carries the toner image G composed of the monochrome toner images formed by the monochrome units 21 and transfers the toner image G to a medium P that is transported thereto. As illustrated in FIG. 1, the transfer device 30 includes the belt TB, four transfer rollers 32, a driving roller 34, a second transfer portion 36, and a tension roller (not illustrated).

The belt TB has an endless shape. The four transfer rollers 32 are provided across the belt TB from the respective photoconductors 22 in such a manner as form respective nips. A voltage is applied to each of the transfer rollers 32 from a power supply (not illustrated), whereby the monochrome toner images on the respective photoconductors 22 are transferred to the belt TB in first transfer. The driving roller 34 is powered by a drive source (not illustrated) and rotates around its own axis, thereby rotating the belt TB in the direction of an arrow A. The second transfer portion 36 transfers, in second transfer, the toner image G carried by the belt TB to a medium P transported thereto by the transporting portion 50.

### Fixing Device

The fixing device 40 fixes the toner image G thus transferred to the medium P by the transfer device 30. Herein, fixing the toner image G on the medium P means that an image is formed on the medium P.

### Transporting Portion

The transporting portion 50 allows the medium P to pass through the second transfer portion 36 and through the fixing device 40 along a medium-transport path and delivers the medium P to the cooling device 60 to be described later. The transporting portion 50 is an exemplary second transporting device. In FIGS. 1 and 2, the dash-dot-dot line represents the medium-transport path, and an arrow B represents the direction in which the medium P is transported.

### Post-Forming-Operation Section

The post-forming-operation section 14 performs a post-forming operation on the medium P having the image formed thereon. The post-forming-operation section 14 includes the cooling device 60, a decurling device 62, and a detecting device 64.

The cooling device 60 cools the medium P having the image while transporting the medium P along the transport path. The decurling device 62 decurls the medium P thus cooled by the cooling device 60. The detecting device 64 detects the occurrence or the degree of any defects, such as a defect in toner density, an image defect, and a defect in image position, regarding the image formed on the medium P. The cooling device 60 will further be described later.

### Controller

The controller 16 controls the elements, excluding the controller 16 itself, included in the image forming apparatus 10. For example, the controller 16 controls the elements (causes the elements to perform respective operations) in accordance with job data received from an external apparatus (not illustrated). The job data includes pieces of image data provided to the monochrome units 21 for forming respective monochrome toner images. The operation of the controller 16 will further be described in conjunction with the image forming operation and the post-forming operation performed by the image forming apparatus 10.

### Image Forming Operation and Post-Forming Operation

The image forming operation and the post-forming operation performed by the image forming apparatus 10 according to the present exemplary embodiment will now be described with reference to FIG. 1.

When the controller 16 receives the job data from the external apparatus (not illustrated), the controller 16 activates the toner-image-forming portion 20, the transfer device 30, the transporting portion 50, and the fixing device 40.

In the toner-image-forming portion 20 thus activated, the charging devices 24 charge the respective photoconductors 22, the exposure devices 26 expose the respective photoconductors 22 to light (and thus form respective latent images), and the developing devices 28 develop the latent images on the photoconductors 22. Thus, monochrome toner images in different colors are formed on the respective photoconductors 22.

Meanwhile, a voltage (a first transfer voltage) is applied to the transfer rollers 32 from the power supply (not illustrated). Furthermore, the drive source (not illustrated) drives the driving roller 34 and thus rotates the belt TB in the direction of the arrow A. Thus, the monochrome toner images in the respective colors are transferred to the belt TB and are integrated into a toner image G in the first transfer.

Synchronously with the reaching of the toner image G, being carried by the belt TB under rotation, to the second transfer portion 36, the transporting portion 50 sends a medium P into the second transfer portion 36. Meanwhile, a voltage (a second transfer voltage) is applied to the second transfer portion 36 from the power supply (not illustrated). Thus, the toner image G is transferred to the medium P passing through the second transfer portion 36 in the second transfer.

Then, the transporting portion 50 sends the medium P, having the toner image G transferred thereto in the second transfer, into the fixing device 40. Thus, the toner image G on the medium P passing through the fixing device 40 is fixed (an image is formed). Through the above series of steps, the image forming operation performed by the image forming apparatus 10 is complete. The transporting portion 50 then delivers the medium P having the fixed image to the cooling device 60, where the post-forming operation is performed.

The medium P delivered to the cooling device 60 from the transporting portion 50 is cooled while being transported along the transport path by the cooling device 60. The medium P thus cooled is decurled by the decurling device 62. The medium P thus decurled undergoes detection by the detecting device 64 for the occurrence or the degree of any defects such as a defect in toner density, an image defect, and a defect in image position. Then, the medium P is discharged to the outside of the image forming apparatus 10. Thus, the post-forming operation ends.

### Featured Configuration (Cooling Device)

The cooling device 60 will now be described with reference to relevant drawings. As described above, the cooling device 60 cools the medium P having the image while transporting the medium P along the transport path. Specifically, the cooling device 60 cools the medium P while holding the medium P between a belt B1 and a belt B2, which will be described later. The cooling device 60 is an exemplary transporting device. If the transporting portion 50 is regarded as an exemplary second transporting device, the cooling device 60 is regarded as an exemplary first transporting device. Herein, the transporting mechanism 55 (see FIG. 1) as a combination of the transporting portion 50 and the cooling device 60 and that transports the medium P is defined as a transporting system.

Referring to FIG. 2, the cooling device 60 includes a first unit 70 and a second unit 80.

### First Unit

The first unit 70 includes the belt B1, a driving roller 72, a drive source (not illustrated), a steering roller 74, an optical sensor (not illustrated), three follower rollers 76A, 76B, and 76C, and a heat sink 78. The belt B1 has an endless shape. Five rollers: namely, the driving roller 72, the steering roller 74, and the three follower rollers 76A to 76C, each extend in the apparatus-depth direction and stretch the belt B1 from the inner side of the belt B1. Hence, when seen from the front side of the cooling device 60 (the image forming apparatus 10), the belt B1 has, for example, a pentagonal shape. The driving roller 72, the follower roller 76A, the follower roller 76B, the steering roller 74, and the follower roller 76C are arranged in that order clockwise when seen from the front side of the cooling device 60.

### Belt B1 and Driving Roller

The driving roller 72 is driven by the drive source (not illustrated) and thus rotates around its own axis, whereby the driving roller 72 rotates the belt B1, provided therearound, in the direction of an arrow C (counterclockwise when seen from the front side of the cooling device 60) as described above. The driving roller 72 is an exemplary rotatable member. From a different point of view, the belt B1 rotates in the direction of the arrow C, illustrated in FIGS. 1 and 2, with the rotation of the driving roller 72 around its own axis. The belt B1 is an exemplary first belt.

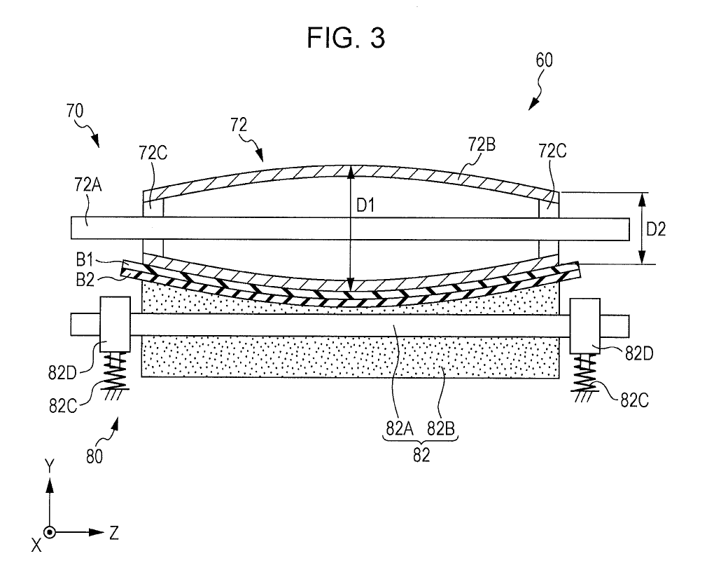

Referring to FIG. 3, the driving roller 72 includes a shaft 72A, a cylinder 72B, and a pair of flanges 72C. The shaft 72A extends through the cylinder 72B, with two ends thereof sticking out of two respective ends of the cylinder 72B. The shaft 72A supports the cylinder 72B by using the pair of flanges 72C fitted thereon near the two respective ends thereof.

As illustrated in FIG. 3, the cylinder 72B has an outside diameter D1 at the axial (longitudinal) center thereof and an outside diameter D2 at each of the two axial ends thereof. The outside diameter D1 is larger than the outside diameter D2. When seen in a direction orthogonal to the axial direction, the cylinder 72B has a barrel-like shape (also referred to as “crown shape”).

### Steering Roller and Optical Sensor

The steering roller 74 shifts the belt B1, provided therearound, in the axial direction thereof (in the width direction of the belt B1). The steering roller 74 is an exemplary first shifting member.

As illustrated in FIG. 2, the steering roller 74 includes a shaft 74A and a cylinder 74B. The shaft 74A is fitted in the cylinder 74B, with two ends thereof sticking out of two respective ends of the cylinder 74B. The steering roller 74 is configured such that the inclination thereof with respect to the apparatus-depth direction is variable with the rotation of cams (not illustrated) that are provided in contact with the outer circumferences of and near two respective ends of the shaft 74A. The rotation of the cams is controlled by the controller 16.

The optical sensor (not illustrated) detects the positions of two respective ends of the belt B1. If the optical sensor has detected that either of the ends of the belt B1 that is under rotation has gone over a predetermined position, the controller 16 rotates the cams and thus changes the inclination of the steering roller 74. As a result, the steering roller 74 shifts the belt B1 to a position on the inner side of the predetermined position. In the present exemplary embodiment, a combination of the steering roller 74, the optical sensor (not illustrated), and the controller 16 serves as a so-called active steering mechanism that controls the skew of the belt B1. The two ends of the cylinder 74B of the steering roller 74 according to the present exemplary embodiment do not extend beyond the two respective ends of the belt B1.

### Heat Sink

The heat sink 78 absorbs heat from the medium P through the belt B1. As illustrated in FIG. 2, the heat sink 78 is provided on the inner side of the belt B1 and is in contact with the inner surface of the belt B1 at a position on the upstream side with respect to the driving roller 72 and on the downstream side with respect to the follower roller 76A in the direction of rotation of the belt B1.

### Second Unit

The second unit 80 includes the belt B2, an elastic roller 82, a steering roller 84, an optical sensor (not illustrated), and three follower rollers 86A, 86B, and 86C. The belt B2 has an endless shape. Five rollers: namely, the elastic roller 82, the steering roller 84, and the three follower rollers 86A to 86C, each extend in the apparatus-depth direction and stretch the belt B2 from the inner side of the belt B2. Hence, when seen from the front side of the cooling device 60 (the image forming apparatus 10), the belt B2 has, for example, a pentagonal shape that is different from that of the belt B1. The elastic roller 82, the follower roller 86A, the steering roller 84, the follower roller 86B, and the follower roller 86C are arranged in that order clockwise when seen from the front side of the cooling device 60.

### Belt B2, Follower Roller 86C, and Elastic Roller

The elastic roller 82 is provided across the belt B1 and the belt B2 from the driving roller 72. The belt B1 and the belt B2 are held between the elastic roller 82 and the driving roller 72, whereby a nip N is formed. The elastic roller 82 is an exemplary forming member. The elastic roller 82 includes a shaft 82A and a cylinder 82B. The shaft 82A is fitted in the cylinder 82B, with two ends thereof sticking out of two respective ends of the cylinder 82B. The cylinder 82B has an outside diameter that is substantially constant over the entirety in the axial direction thereof. The cylinder 82B according to the present exemplary embodiment is made of an elastic material such as rubber or foam and is softer than the cylinder 72B of the driving roller 72. The elastic roller 82 (the shaft 82A) is supported at the two ends thereof by respective bearings 82D. The bearings 82D are urged by respective coil springs 82C. Thus, the elastic roller 82 is pressed toward the driving roller 72. The follower roller 86C is provided across the belt B1 and the belt B2 from the heat sink 78.

In the above configuration, the belt B2 is in contact with the belt B1 in a portion PT that is on the downstream side with respect to the follower roller 86C and on the upstream side with respect to the elastic roller 82 in the direction of rotation of the belt B2 (a portion of the belt B1 that corresponds to the portion PT of the belt B2 is also hereinafter denoted as “portion PT”). When the driving roller 72 rotates around its own axis, the belt B2 receives a frictional force from the belt B1 and thus rotates in the direction of an arrow D illustrated in FIGS. 1 and 2. Thus, the belt B2 and the belt B1 cooperate to transport the medium P while nipping the medium P between the respective portions PT. The belt B2 is an exemplary second belt. The portions PT are exemplary portions of the first and second belts excluding portions that form the nip N.

### Steering Roller and Optical Sensor

The steering roller 84 shifts the belt B2, provided therearound, in the axial direction thereof (in the width direction of the belt B2). The steering roller 84 is an exemplary second shifting member.

As illustrated in FIG. 2, the steering roller 84 includes a shaft 84A and a cylinder 84B, as with the steering roller 74. The steering roller 84 is configured such that the inclination thereof with respect to the apparatus-depth direction is variable with the rotation of cams (not illustrated) that are provided in contact with the outer circumferences of and near two respective ends of the shaft 84A. The optical sensor (not illustrated) detects the positions of two respective ends of the belt B2. If the optical sensor has detected that either of the ends of the belt B2 that is under rotation has gone over a predetermined position, the controller 16 rotates the cams and thus changes the inclination of the steering roller 84. As a result, the steering roller 84 shifts the belt B2 to a position on the inner side of the predetermined position. In the present exemplary embodiment, a combination of the steering roller 84, the optical sensor (not illustrated), and the controller 16 serves as a so-called active steering mechanism that controls the skew of the belt B2. The two ends of the cylinder 84B of the steering roller 84 according to the present exemplary embodiment do not extend beyond the two respective ends of the belt B2.

### Relationship Between First Unit and Second Unit

A relationship between the first unit 70 and the second unit 80 will now be described.

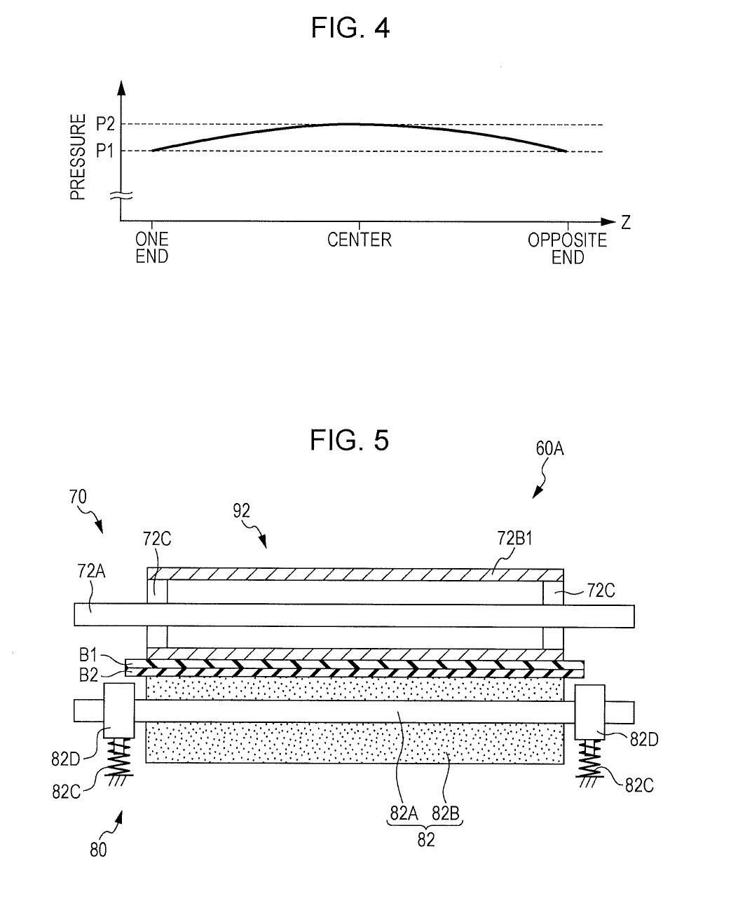

As described above, the driving roller 72 (the cylinder 72B) of the first unit 70 has the outside diameter D1 at the axial (longitudinal) center thereof and the outside diameter D2 at each of the two axial ends thereof, and the outside diameter D1 is larger than the outside diameter D2. On the other hand, the elastic roller 82 (the cylinder 82B) of the second unit 80 has a substantially constant outside diameter over the entirety in the axial direction thereof, and the cylinder 82B is softer than the cylinder 72B of the driving roller 72. Therefore, in the present exemplary embodiment where the driving roller 72 and the elastic roller 82 cooperate to form the nip N between the belt B1 and the belt B2 as illustrated in FIG. 3, a portion of the cylinder 82B of the elastic roller 82 at the nip N is deformed with the axial center thereof being depressed. In this state, as graphed in FIG. 4, the pressure applied to the portion of the cylinder 72B (of the driving roller 72) at the nip N is greatest, P2, at the center and is smallest, P1, at each of the two axial ends. From a different point of view, a value obtained by dividing the pressure P1 at each of the two axial ends of the driving roller 72 (the cylinder 72B) by the pressure P2 at the axial center of the driving roller 72 (the cylinder 72B) is lower than 1 or lower than about 1 (the value is hereinafter referred to as “pressure ratio”). Accordingly, the driving roller 72 and the elastic roller 82 form the nip N such that the pressure ratio becomes lower than 1 or lower than about 1. Specifically, the pressure ratio according to the present exemplary embodiment is set to, for example, 0.9. That is, the pressure ratio is set within a range above 0.75 or about 0.75 and below 1.0 or about 1.0 (0.75<pressure ratio<1.0). The pressure P1 and the pressure P2 may be measured by using, for example, a contact-pressure-distribution-measuring system called I-SCAN (manufactured by NITTA Corporation). In the present exemplary embodiment, as described above, the portion of the cylinder 82B of the elastic roller 82 at the nip N is deformed with the axial center thereof being depressed. Hence, the portion of the cylinder 72B of the driving roller 72 at the nip N is in contact with the belt B1 by a larger width, in the circumferential direction of the belt B1, at the axial center than at each of the two axial ends. Likewise, the portion of the cylinder 82B of the elastic roller 82 at the nip N is in contact with the belt B2 by a larger width, in the circumferential direction of the belt B2, at the axial center than at each of the two axial ends.

### Functions

Functions (first and second functions) exerted by the present exemplary embodiment will now be described.

### First Function

The first function is exerted by the fact that the pressure ratio is lower than 1.0 or lower than about 1.0. The first function of the present exemplary embodiment will first be described in comparison with functions exerted in comparative embodiments (first and second comparative embodiments) given below and with reference to relevant drawings. In the following description of the comparative embodiments, any elements that are the same as those employed in the comparative exemplary embodiments are denoted by corresponding ones of the reference numerals used in the present exemplary embodiment, whether or not they are illustrated in the drawings.

Referring to FIG. 5, a cooling device 60A according to the first comparative embodiment includes a driving roller 92 that includes a cylinder 72B1. The cylinder 72B1 is different from the cylinder 72B according to the present exemplary embodiment. The cylinder 72B1 has a substantially constant outside diameter over the entirety in the axial direction thereof. Therefore, as graphed in FIG. 7, in the first comparative embodiment, the pressure applied to a portion of the cylinder 72B1 at the nip N is substantially the same between that at the center and that at each of two ends (the pressure is substantially constant over the entirety in the axial direction). Specifically, in the first comparative embodiment, the pressure ratio is 1.0. The other factors of the first comparative embodiment are the same as those of the present exemplary embodiment.

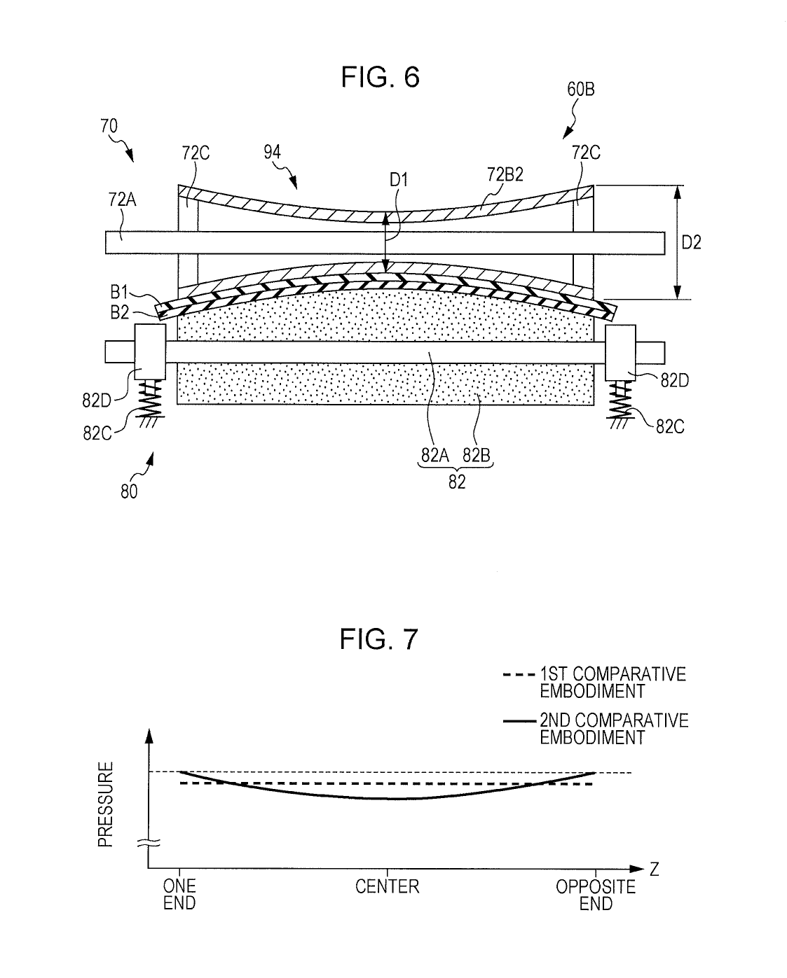

Referring now to FIG. 6, a cooling device 60B according to the second comparative embodiment includes a driving roller 94 that includes a cylinder 72B2. The cylinder 72B2 is different from the cylinder 72B according to the present exemplary embodiment. The cylinder 72B2 has an outside diameter D1 at the axial (longitudinal) center thereof and an outside diameter D2 at each of the two axial ends thereof, and the outside diameter D1 is smaller than the outside diameter D2. When seen in a direction orthogonal to the axial direction, the cylinder 72B2 has a shape descending from the two sides to the center (also referred to as “inverted crown shape”). Therefore, in the second comparative embodiment, the pressure applied to a portion of the cylinder 72B2 at the nip N is smaller at the center than at each of the two ends. Specifically, in the second comparative embodiment, the pressure ratio is higher than 1.0 (for example, 1.15). The other factors of the second comparative embodiment are the same as those of the present exemplary embodiment.

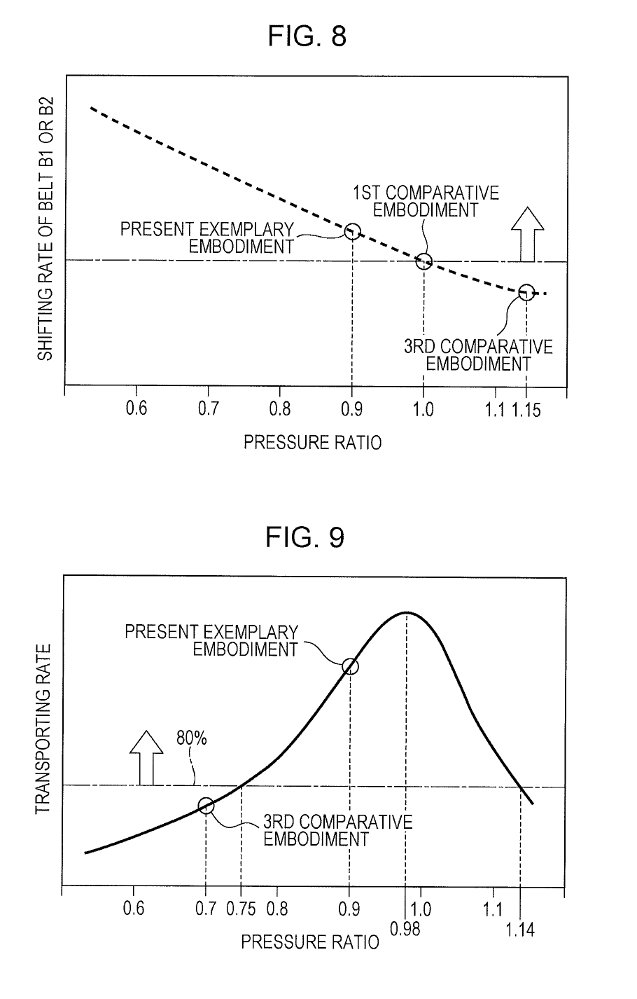

FIG. 8 is a graph illustrating a relationship between the pressure ratio and a rate at which the belt B1 or the belt B2 is shifted in the width direction (the apparatus-depth direction) (the rate is hereinafter also referred to as “shifting rate”). The shifting rate refers to the percentage of the length of shifting of the belt B1 (or B2) in the width direction with respect to the length of travel of the belt B1 (or B2) in the direction of rotation of the belt B1 (or B2) per unit time. Referring to the graph in FIG. 8, as the pressure ratio becomes higher, the shifting rate becomes lower. The reason for this is as follows. Even if it is attempted to shift the belt B1 (or B2) from one side toward the other side in the width direction by changing the inclination of the steering roller 74 (or 84), the belt B1 (or B2) is difficult to shift because the pressure applied to each of the two ends of the nip N is greater than the pressure applied to the center of the nip N. Referring to the graph in FIG. 8, when the pressure ratio is lower than 1.0 or lower than about 1.0, the shifting rate changes linearly. However, as the pressure ratio becomes 1.0 or higher (higher than a threshold of 1.0), the sensitivity of the shifting rate with respect to the pressure ratio becomes lower than that observed when the pressure ratio is lower than 1.0 or lower than about 1.0. Focusing on this respect, the present inventors have found that, in terms of sensitivity of the shifting rate, the shifting rate is preferably plotted above the dash-dot line in the graph illustrated in FIG. 8; that is, the pressure ratio is preferably lower than 1.0 or lower than about 1.0. Accordingly, the configuration in which the pressure ratio is 1.0 or higher, as in the first comparative embodiment (the pressure ratio is 1.0) and in the second comparative embodiment (the pressure ratio is 1.15), is not preferable in terms of sensitivity of the shifting rate. Particularly, if the belt B1 and the belt B2 are to be shifted in opposite directions, the belt B1 and the belt B2 hinder each other's movement because the two are in contact with each other at the respective portions PT (see FIG. 2). In this respect also, the pressure ratio is preferably lower than 1.0 or lower than about 1.0.

Hence, in the cooling device 60 according to the present exemplary embodiment, the steering roller 74 (or the steering roller 84) shifts the belt B1 (or the belt B2) in the width direction more easily than in the case where the pressure ratio is 1.0 or higher. This is true even if the cooling device 60 according to the present exemplary embodiment is configured such that the belt B1 and the belt B2 are in contact with each other at the respective portions PT (see FIG. 2).

### Second Function

The second function is exerted by the fact that the pressure ratio is higher than 0.75 or higher than about 0.75 (0.75<pressure ratio) and by the fact that the pressure ratio is lower than 1.0 or lower than about 1.0 and higher than 0.75 or higher than about 0.75 (0.75<pressure ratio<1.0). The second function will now be described by comparing the present exemplary embodiment and a third comparative embodiment given below and with reference to relevant drawings. In the following description of the third comparative embodiment, any elements that are the same as those employed in the present exemplary embodiment are denoted by corresponding ones of the reference numerals used in the present exemplary embodiment, whether or not they are illustrated in the drawings.

A cooling device (not illustrated) according to the third comparative embodiment includes a driving roller that includes a cylinder different from the cylinder 72B according to the present exemplary embodiment. Specifically, the cylinder according to the third comparative embodiment has a crown shape as with the cylinder 72B according to the present exemplary embodiment but is under a pressure ratio that is lower than 0.75 (for example, 0.7). The other factors of the third comparative embodiment are the same as those of the present exemplary embodiment.

FIG. 9 is a graph illustrating a relationship between the pressure ratio and a rate at which the medium P is transported by the belt B1 or the belt B2 (the rate is hereinafter also referred to as “transporting rate”). The transporting rate refers to the percentage of the length of travel of the medium P in the direction of transport (the direction of the arrow B illustrated in FIG. 2) with respect to the number of revolutions of the driving roller per unit time. According to the graph in FIG. 9, the transporting rate is highest when the pressure ratio is 0.98 (about 1.0). Furthermore, the transporting rate becomes lower as the pressure ratio becomes lower than 0.98 and as the pressure ratio becomes higher than 0.98 (about 1.0). The reason for this is as follows. As the pressure ratio becomes lower than about 1.0, the central portion of the cylinder of the driving roller bulges more outward. Consequently, it becomes more difficult to transmit the driving force to the belt B1. On the other hand, as the pressure ratio becomes higher than about 1.0, the central portion of the cylinder of the driving roller is depressed more deeply. Consequently, it becomes more difficult to transmit the driving force to the belt B1. The present inventors have found that a medium P and a subsequent medium P that are successively delivered to the cooling device 60 from the transporting portion 50 are transported without being jammed between the portions PT if the transporting rate of the cooling device 60 is higher than 80%. Referring to the graph in FIG. 9, the transporting rate is higher than 80% when the transporting rate is plotted above the dash-dot line; that is, when the pressure ratio is higher than 0.75 and lower than 1.14. Hence, the third comparative embodiment in which the pressure ratio is 0.7 is not preferable in terms of the occurrence of a jam.

Therefore, in the transporting mechanism 55 according to the present exemplary embodiment, the probability that media P may be jammed between the portions PT of the belts B1 and B2 in the cooling device 60 is lower than in the case where the pressure ratio is 0.75 or lower. Furthermore, in the transporting mechanism 55 according to the present exemplary embodiment, it is easier for the steering roller 74 (or the steering roller 84) to shift the belt B1 (or the belt B2) in the width direction and the probability that media P may be jammed between the portions PT of the belts B1 and B2 in the cooling device 60 is lower than in the case where the pressure ratio is 0.75 or lower or 1.0 or higher. Therefore, in the image forming apparatus 10 according to the present exemplary embodiment, the occurrence of a defect in image formation due to a jam of media P is suppressed more than in the case where the pressure ratio is 0.75 or lower or 1.0 or higher.

While a specific exemplary embodiment of the present invention has been described above, the technical scope of the present invention encompasses other exemplary embodiments, including the following, for example.

The above exemplary embodiment concerns a case where the driving roller 72 is an exemplary rotatable member. Alternatively, the rotatable member is not limited to the driving roller 72 and may be, for example, any of the follower rollers, as long as the rotatable member and the elastic roller 82 hold the belt B1 and the belt B2 therebetween and form a nip N at a pressure ratio lower than 1.0 or lower than about 1.0.

The above exemplary embodiment concerns a case where the belt B1 as an exemplary first belt and the belt B2 as an exemplary second belt are each stretched around five rollers and thus have, for example, a pentagonal shape when seen in the apparatus-depth direction. Alternatively, the first belt and the second belt each do not necessarily have a pentagonal shape and may each have, for example, an elongated shape (by being stretched between two rollers) or any other polygonal shape when seen in the apparatus-depth direction, as long as the cooling device 60 includes a first belt, a second belt, a first shifting member, a second shifting member, a rotatable member, and a forming member, with the rotatable member and the forming member cooperating to form a nip N at a pressure ratio lower than 1.0 or lower than about 1.0.

The above exemplary embodiment concerns a case where the cooling device 60 is an exemplary transporting device. Alternatively, the transporting device is not limited to the cooling device 60 and may be, for example, a transfer device or a fixing device, as long as such a device includes a first belt, a second belt, a first shifting member, a second shifting member, a rotatable member, and a forming member, with the rotatable member and the forming member cooperating to form a nip N at a pressure ratio lower than 1.0 or lower than about 1.0.

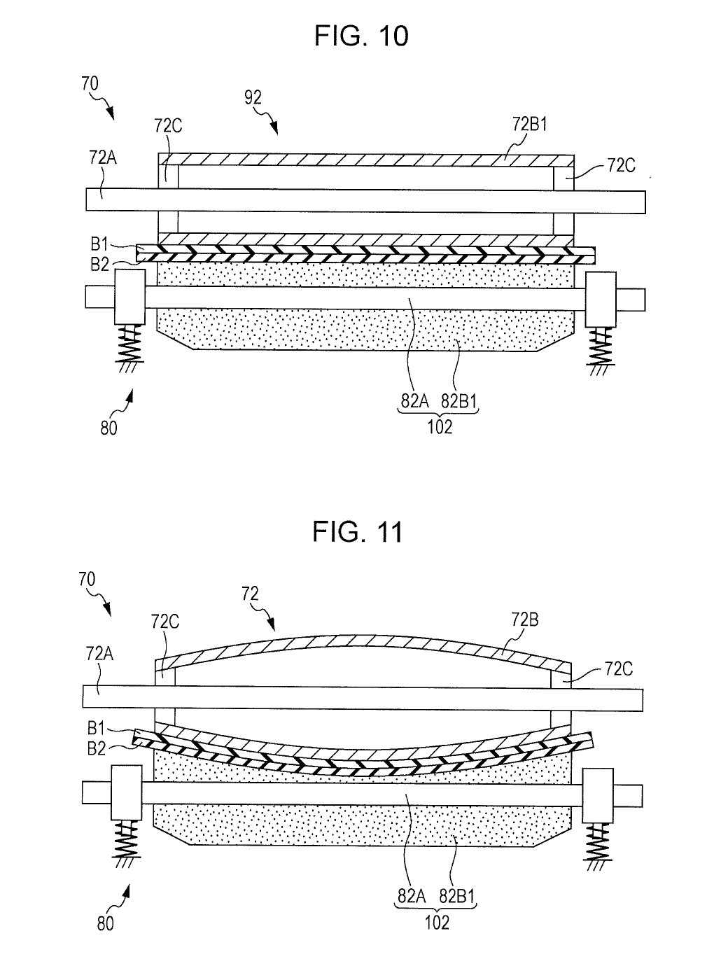

The above exemplary embodiment concerns a case where, as illustrated in FIG. 3, the driving roller 72 (the cylinder 72B) has the outside diameter D1 at the axial (longitudinal) center thereof that is larger than the outside diameter D2 at each of the two axial ends thereof, and the elastic roller 82 (the cylinder 82B) has an outside diameter that is substantially constant over the entirety in the axial direction thereof. Alternatively, the driving roller 72 and the elastic roller 82 may each have another shape, as long as the driving roller 72 and the elastic roller 82 cooperate to form a nip N at a pressure ratio lower than 1.0 or lower than about 1.0. For example, a first modification illustrated in FIG. 10 is as follows. The driving roller 92 according to the first comparative embodiment is employed in replacement of the driving roller 72, an elastic roller 102 including a cylinder 82B1 whose outside diameter at each of the two ends thereof is gradually reduced from the center side to the extreme end is employed in replacement of the elastic roller 82, and a nip N is formed by the two rollers 92 and 102 such that the pressure ratio is lower than 1.0 or lower than about 1.0. In the first modification, the driving roller 92 is an exemplary rotatable member, and the elastic roller 102 is an exemplary forming member. For another example, a second modification illustrated in FIG. 11 is as follows. The elastic roller 102 is employed in replacement of the elastic roller 82, and a nip N is formed between the driving roller 72 and the elastic roller 102 such that the pressure ratio is lower than 1.0 or lower than about 1.0. In the second modification, the elastic roller 102 is an exemplary forming member.

The above exemplary embodiment concerns a case where the belt B1 and the belt B2 are each shifted in the width direction by a so-called active steering mechanism. Alternatively, the steering mechanism is not limited to be of an active type and may be of, for example, a passive type, as long as the mechanism is capable of shifting the belt B1 (or the belt B2) in the width direction by changing the inclination of the steering roller 74 (or the steering roller 84).

The above exemplary embodiment concerns a case where the image forming apparatus 10 employing an electrophotographic method is an exemplary image forming apparatus. Alternatively, the image forming apparatus is not limited to an apparatus employing an electrophotographic method, as long as the apparatus includes a transporting device that includes a first belt, a second belt, a first shifting member, a second shifting member, a rotatable member, and a forming member, with the rotatable member and the forming member cooperating to form a nip N at a pressure ratio lower than 1.0 or lower than about 1.0. For example, the image forming apparatus may employ an inkjet image forming method or any other like image forming method.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transporting device comprising:
a rotatable first belt;
a rotatable second belt that transports a medium in cooperation with the first belt;
a first shifting member around which the first belt is provided and that shifts the first belt in a width direction of the first belt;
a second shifting member around which the second belt is provided and that shifts the second belt in a width direction of the second belt;
a rotatable member around which the first belt is provided and that is rotatable around an axis of the rotatable member; and
a forming member provided across the first belt and the second belt from the rotatable member and that forms a nip between the first belt and the second belt in cooperation with the rotatable member,
wherein the rotatable member and the forming member cooperate to form the nip at a pressure ratio in a range of 0.75 to 0.98, the pressure ratio being obtained by dividing a pressure applied to each of two axial ends of the rotatable member by a pressure applied to an axial center of the rotatable member.

2. The transporting device according to claim 1, wherein the first belt and the second belt transport the medium while holding the medium between respective portions excluding portions that form the nip.

3. A transporting system comprising:
a first transporting device as the transporting device according to claim 1; and
a second transporting device that transports the medium to be delivered to the first transporting device.

4. An image forming apparatus comprising:
the transporting system according to claim 3; and
an image forming section that forms an image on the medium to be transported to the transporting system.
